(19) United States
(12) Patent Application Publication
(10) Pub. No.: US 2013/0337142 A1
(43) Pub. Date: Dec. 19, 2013

(54) METHOD OF TREATING A DIVIDED CHEESE PRODUCT FOR ANTICAKING AND COMPOSITIONS THEREOF

(71) Applicant: Allied Blending & Ingredients, Inc., St. Louis, MO (US)

(72) Inventors: John E. Fannon, St. Louis, MO (US); Kent R. Anderson, Burlington, IA (US)

(21) Appl. No.: 13/917,902

(22) Filed: Jun. 14, 2013

Related U.S. Application Data
(60) Provisional application No. 61/659,809, filed on Jun. 14, 2012.
(60) Provisional application No. 61/730,812, filed on Nov. 28, 2012.

(51) Int. Cl. A23C 19/14

(52) U.S. Cl. CPC A23C 19/14
USPC 426/582; 426/661

(57) ABSTRACT

Disclosed herein is an improved anticaking product for use on cheese, especially in the pizza pie industry, wherein the product is economical and has superior functional properties of reducing sticking of chunked, diced or shredded cheeses.

This application claims the benefit of priority of U.S. provisional applications No. 61/659,809, filed Jun. 14, 2012, and No. 61/730,812, filed Nov. 28, 2012, the disclosures of which are hereby incorporated by reference as if written herein in their entireties.

Anticaking agent in the food industry, especially in the dairy and cheese industry, is defined as any safe and suitable food ingredient which, when added, should prevent lumping of shredded, diced or chunked dairy product, such as cheese, during storage at room temperature or refrigerator or freezer. Such a dairy product with anticaking agent in it should be easy to handle at the time of applying on the final food product. Some cheeses, after they are chunked and if the anticaking agent is not used, will cake and are very difficult to handle. This is a serious problem especially with high moisture and high fat cheeses. Currently, at least 50% to 75% of the hard and semi-hard cheeses are either diced, shredded or chunked for sale in grocery stores, institutions, and major restaurant chains in the United States.

Several anticaking agents are commercially available, such as cellulose, microcrystalline cellulose, cellulose impregnated with glucose sugar and glucose oxidase enzyme, silicon dioxide, and sodium aluminum silicate. The major drawbacks of the existing anticaking agents are as follows:
1. Relatively expensive.
2. Deteriorates the product functionality in terms of performance in the finished products.
3. The product efficiency is questionable depending on the chemical specification of the cheese.
4. Too much dusting in the packaging room.
5. Health hazard to workers.
6. Excessive, unwanted bacteria and yeast and mold contamination.

Primarily, anticaking agents are formulated to include compounds which will eliminate sticking. One commonly used anticaking compound is cellulose, which is a fibrous vegetable material. Some formulations include starch in the anticaking agent, and many employ cellulose in combination with dextrose sugar and glucose oxidase. In the last mentioned case, the intent is to reduce oxygen in the packaged treated product in order to eliminate yeast and molds and, at the same time, to prevent the treated product from caking.

Also, the efficiency of such procedures to perform consistently is highly questionable because of the variance in chemical specifications of the cheeses. Enzymatic reactions require proper temperatures, moisture, pH, and, most importantly, time to react and produce the final result. In the pizza industry, it is a known problem that higher use of cellulose based anticaking agents tends to interfere with baking qualities of cheeses in terms of melt and browning. This problem is recent in origin because, formerly, temperatures of pizza baking ovens were maintained at 400° to 475° F. More recently, with the concept of fast served foods such as five minute pizza for lunch trade and 30 minute home delivery of pizza, pizza is baked at 575° to 650° F. With this higher temperature baking, the problems associated with cheese and anticaking agents are magnified. A serious problem is excessive browning and scorching of cheeses on pizza pie at such elevated temperatures.

Traditionally pizza cheese makers use 1-2% cellulose as an anticaking agent because it does not increase browning of the cheese when baked on a pizza. Starch-based anticaking agents are advantageous to cellulose-based agents due to the higher usage rate and lower cost of the starch-based agents. However, existing starch-based anticaking agents cause the cheese to develop too much browning on the pizza.

It would therefore be beneficial to develop starch-based anticaking agents that do not cause the development of too much browning on the cheese during cooking.

### SUMMARY OF INVENTION

Disclosed herein is an improved anticaking product for use on cheese, especially in the pizza pie industry, wherein the product is economical and has superior functional properties of reducing sticking of chunked, diced or shredded cheeses.

A specific object is to provide an anticaking agent for use on cheese in the pizza pie industry, wherein the agent promotes the melt of cheese, reduces browning, and improves flavor and texture.

A further object is to include flavor compounds in the anticaking agent to eliminate the flavor discrepancies in the finished product.

In an embodiment, the anticaking agent is formed of a starch loaded with a fat or fat replacement.

In an embodiment, the anticaking agent comprises:
1. 60%-95% starch; and
2. 5%-40% fat or fat replacement.

In an embodiment, the anticaking agent comprises:
1. 70%-90% starch; and
2. 10%-30% fat or fat replacement.

In an embodiment, the starch is an unmodified food starch.

In an embodiment, the starch is an unmodified corn starch.

In an embodiment, the starch is a plating starch.

In an embodiment, the starch is an unmodified high amylose corn starch.

In an embodiment, the starch is a modified starch.

In an embodiment, the starch is a modified corn starch.

In an embodiment, the starch is chosen from a highly cross-linked flash-dried starch, an acid-hydrolyzed starch, and an enzyme-hydrolyzed starch.

In an embodiment, the fat is an oil.

In an embodiment, the oil is chosen from sunflower oil, canola oil, mineral oil, corn oil, and soy oil.

In an embodiment, the fat replacement is maltodextrin.

In an embodiment, the fat is kosher approved mono-diglycerides made from edible, refined, fully hydrogenated vegetable fat.

In an embodiment, said composition further comprises a calcium compound.

Certain embodiments as disclosed herein provide compositions for treating divided cheese to prevent sticking, clumping, or caking and, in particular, preventing caking while providing good melt, flavor and textural properties, and inhibiting excess browning during cooking.

In an embodiment, the anticaking agent further comprises a calcium compound.

In certain embodiments, the agent may comprise 30.00-65.00% starch, 30.00-65.00% calcium compound, and 0.10-40.00% fat by weight.

In certain embodiments, the agent may comprise 40.00-60.00% starch, 40.00-60.00% calcium compound, and 1.00-5.00% fat by weight.

In a specific embodiment, the agent may comprise 49.38% starch; 49.38% calcium compound; and 1.24% fat by weight.

In a specific embodiment, the agent may comprise 49.38% distarch phosphate; 49.38% calcium sulfate; and 1.24% sunflower oil by weight.

In various embodiments, the starch may be obtained from corn, potato, wheat, rice, sago, tapioca, and sorghum. In certain embodiments, the starch may be obtained from corn. In certain embodiments, the starch may be obtained from potato.

In various embodiments, the starches used in the invention not only may be native starches but also may be starches that have been modified by cross-linking, derivitization, substitution, or other processes that involve chemical treatment to impart desired functional properties. In certain embodiments, the modified starches may be cross-linked starches, which may comprise a native starch that has been cross-linked via any suitable cross-linking technique known in the art or otherwise found to be suitable in conjunction with the invention.

In various embodiments, the fat used in the invention may be an oil. In certain embodiments, the oil may be sunflower oil, canola oil, palm oil, cottonseed oil, mineral oil, corn oil, or soybean oil. In a specific embodiment, the oil is sunflower oil.

In various embodiments, the calcium compound may be calcium carbonate, calcium citrate, calcium silicate, calcium stearate, or calcium sulfate. In a specific embodiment, the calcium compound is calcium sulfate.

In various embodiments, the present invention provides a food product comprising divided cheese comprising a plurality of individual cheese particles, and an anti-caking agent described above dispersed on the individual cheese particles in an amount sufficient to inhibit caking of the individual cheese particles.

In an embodiment, said agent further comprises a processing aid or flow agent.

In an embodiment, said processing aid or flow agent is chosen from silicon dioxide and calcium phosphate.

In an embodiment, said processing aid or flow agent comprises less than 0.5% of the agent by weight.

Disclosed herein is a method of treating a divided or shredded food product for anticaking comprising applying to said cheese an anticaking agent as described herein.

Disclosed herein is a method of reducing browning of a divided or shredded food product comprising applying to said food product an anticaking agent as described herein prior to cooking.

In an embodiment, said food product is chosen from cheese, cheese analogue, cheese substitute, cheese extender, and processed cheese.

In an embodiment, said agent may be combined with glycerin, oil, or water to aid in the treating of said divided or shredded food product.

### DETAILED DESCRIPTION

The term “cheese” as used herein refers broadly to all types of cheeses including, for example, cheeses as defined under the CODEX general Standard for Cheese and as defined under various state and national regulatory bodies. Exemplary classes of cheeses include, but are not limited to, firm/semi-hard cheeses, soft cheeses, analog cheeses, blended cheeses, and pasta filata cheeses, among other types of cheeses.

Anticaking agent in the food industry, especially in the dairy and cheese industry, is defined as any safe and suitable food ingredient which, when added, should prevent lumping of shredded, diced or chunked food product, such as cheese, during storage at room temperature or refrigerator or freezer. Such a food product with anticaking agent in it should be easy to handle at the time of applying on the final food product. Some cheeses, after they are chunked and if the anticaking agent is not used, will cake and are very difficult to handle. This is a serious problem especially with high moisture and high fat cheeses. Several anticaking agents are commercially available, such as cellulose, microcrystalline cellulose, and starch.

As used herein, the term “calcium compound” refers to compounds containing calcium. Examples of calcium compounds include, but are not limited to, calcium acetate, calcium carbonate, calcium citrate, calcium citrate malate, calcium dihydrogen phosphate, calcium fluoride, calcium formate, calcium glubionate, calcium glucoheptonate, calcium gluconate, calcium glycerylphosphate, calcium lactate, calcium lactate gluconate, calcium magnesium acetate, calcium malate, calcium phosphate, calcium propionate, calcium pyrophosphate, calcium silicate, calcium silicide, calcium sorbate, calcium stearate, calcium sulfate, calcium sulfide, calcium tartrate, calcium(I) chloride, dicalcium citrate, dicalcium phosphate. One of skill in the art will appreciate that other calcium compounds are useful in the present invention.

### EXAMPLES

Examples 1-10 show in Table 1 are for making an anti-caking composition for shredded cheese.

TABLE 1

| Example | | % | | % | Calcium | % |
|---|---|---|---|---|---|---|
| No. | Starch | weight | Fat | weight | Compound | weight |
| 1 | Acid Modified | 49.38 | Sunflower | 1.24 | Calcium | 49.38 |
| | Food Starch | | Oil | | sulfate | |
| 2 | Acid Modified | 49.38 | Sunflower | 1.24 | Calcium | 49.38 |
| | Food Starch with | | Oil | | sulfate | |
| | Cross Linking | | | | | |
| 3 | Distarch | 49.38 | Sunflower | 1.24 | Calcium | 49.38 |
| | phosphate with | | Oil | | sulfate | |
| | substitution | | | | | |
| 4 | Annealed | 49.38 | Sunflower | 1.24 | Calcium | 49.38 |
| | starches | | Oil | | sulfate | |
| 5 | Enzyme | 49.38 | Sunflower | 1.24 | Calcium | 49.38 |
| | Modified Food | | Oil | | sulfate | |
| | Starch | | | | | |
| 6 | Enzyme | 49.38 | Sunflower | 1.24 | Calcium | 49.38 |
| | Modified Food | | Oil | | sulfate | |
| | Starch with | | | | | |
| | Cross Linking | | | | | |
| 7 | Physically | 49.38 | Sunflower | 1.24 | Calcium | 49.38 |
| | modified | | Oil | | sulfate | |
| | starches that | | | | | |
| | mimic | | | | | |
| | crosslinking | | | | | |
| 8 | unmodified high | 70 | Maltrin | 30 | — | 0 |
| | amylose corn | | M040 | | | |
| | starch | | maltodextrin | | | |
| 9 | unmodified high | 90 | Emulsifier | 10 | — | 0 |
| | amylose corn | | HV52 mono & | | | |
| | starch | | diglyceride | | | |
| 10 | highly cross- | 80 | Sunflower | 20 | — | 0 |
| | linked flash- | | Oil | | | |
| | dried starch | | | | | |

### Anticaking Properties

The study was comprised of a series of iterative pizza cheese bake tests. Each bake test contained a control sample—cellulose added to shredded cheese at 1.5% (w/w), and experimental samples—anti-caking blends at 4.0% (w/w). Results from each test were used to improve ingredient blends for subsequent tests. Visual examination of anti-caking effectiveness was completed 1-2 days following addition to the shredded cheese. Anti-caking blends that resulted in pizza cheese shreds sticking or lumping were excluded from the bake tests. The cheese was evaluated in several tests using the following guidelines shown in Table 2.

Cheese was prepared with the anti-caking compositions as follows:
1. Shred cheese using the Kitchen Aid stand mixer (speed setting 2) with the attached coarse shredder. Target average shred size: length—45 mm, width—3-4 mm.
2. Weigh desired quantity of cheese.
3. Place cheese into a 60 ounce plastic container and add anti-caking agent, either 1.5% w/w cellulose powder or 4% w/w experimental anti-caking blend (pre-mixed).
4. Put a lid on the container and shake the container by hand until anti-caking agent is incorporated into the shredded cheese (approximately 15 seconds).
5. Hold the shredded cheese with anti-caking ingredients in the 60 ounce containers at 40° F. for 20-60 hours.
6. For pizza cheese bake evaluation, follow the Pizza Preparation and Evaluation procedure.

Pizza was prepared and evaluated using the following methods:
7. Preheat Impinger Oven to 450° F. Set the bake time for 4 minutes and 30 seconds.
8. Remove up to 4 sets of shredded cheese w/anti-caking ingredient from cooler and up to 4 pizza crusts from a freezer. Place on counter at room temperature.
9. Place 4 Tablespoons of pizza sauce on a 12″ pizza crust and spread uniformly to within about 1″ of the edge. Uniformly distribute 142 grams of cheese with anti-caking agent onto the pizza.
10. Place the pizza on a round pizza screen. Then, place the screen on the conveyor belt and bake the pizza. Do not push pizza into oven; allow the belt to pull the pizza into the Impinger Oven.
11. While cooling, evaluate pizza for browning, oiling and shred using the Pizza Cheese Evaluation Guidelines.
12. After 2 minutes, test string by inserting a fork under the cheese and pulling in an upward motion and noting the height with a ruler at which the cheese breaks.
13. Evaluate flavor, mouthfeel and appearance at 10 minutes.
14. Evaluate pizza cheese appearance after 30 mins and 60 mins. Record any observations.

TABLE 2
Pizza Cheese Evaluation Guidelines

| Test # | Score | Category |
|---|---|---|
| 1 | | Browning |
| | 10 | No or very few small brown spots |
| | 8 | Small brown spots about the size of a dime |
| | 4 | 50% brown spots on surface - some large, some |
| | | small |
| | 1 | 95-100% covered with large (quarter size) brown |
| | | spots on surface |
| 2 | | Oiling |
| | 10 | Slight oil sheen visible |
| | 8 | Very few pools present, smaller than a dime |
| | 4 | Slight pools present, larger than a dime |
| | 1 | Many large pools present |
| 4 | | Shred |
| | 10 | Confluent - melting all together |
| | 8 | Outline of shreds still evident - 10% |
| | 5 | Outline of shreds still evident - 30% |
| | 1 | Little or no sign of melting |
| 5 | | String - at 2 minutes until breakage |
| | | Noted as the actual length of string when |
| | | lifted with fork |
| 6 | | Flavor |
| | 10 | Good flavor - no off tastes |
| | 5 | Some off notes on flavor |
| | 1 | Unacceptable flavor |
| 7 | | Mouthfeel |
| | 10 | Smooth tender body |
| | 8 | Mostly soft or slightly chewy, but smooth |
| | 4 | Moderately tough or chewy, mealy, grainy, |
| | | plastic mouthfeel |
| | 1 | Extremely tough, excessive graininess, |
| | | sandiness, and/or chewiness |
| 8 | | Appearance at 10 minutes |
| | 10 | White or slight off white |
| | 8 | Slightly translucent |
| | 4 | Moderately translucent |
| | 1 | Very translucent |

Overall, pizza cheese evaluation scores for oiling, flavor and mouthfeel between the control and the top performing experimental samples were nearly identical. Some differences were noticed in string, shred, browning and appearance (translucency after 30 to 60 minutes). See Table 3. The “+” and “−” indicate a score slightly above or below the number indicated, respectively.

TABLE 3

| Anti- | | | | | | | | |
|---|---|---|---|---|---|---|---|---|
| Caking | | | | | | | | |
| Blend | Browning | Oiling | Shred | String (in) | Flavor | Mouthfeel | Appearance | Notes |
| Cellulose - | 8− | 10 | 10 | 13 | 10 | 8− | 10 | good sheen, slightly |
| Control | | | | | | | | brown, good flavor, |
| | | | | | | | | slightly chewy, |
| | | | | | | | | creamy appearance |
| Example 8 | 4+ | 10 | 10 | 17 | 10 | 8 | 8 | nice sheen, slight |
| | | | | | | | | yellow tint, good |
| | | | | | | | | appearance after 60 mins |
| Example 9 | 4+ | 10 | 8− | 16 | 10 | 8 | 8 | yellow tint, good |
| | | | | | | | | taste, creamy |
| | | | | | | | | appearance; good |
| | | | | | | | | appearance after 60 mins |

String length is a measure of stretchability of melted cheese which was determined by the “fork test”. It is hard to separate whether the observed differences in the string scores between the control and experimental samples were due to normal variations, operator bias, or were attributable to the anti-caking blends, given the subjective nature of the test. For example, pizza string measurements on the cellulose-based samples, which were conducted throughout the pizza cheese bake tests (n=7), ranged from 10 to 18 inches. A large number of tests are needed for a definitive answer on the effect of a particular anti-caking agent on the string length.

In general, experimental samples scored slightly lower on browning, shred and appearance after 10, 30, and 60 minutes.

Although, all three experimental samples in Table 1 showed great potential, Example 1 was slightly preferred over the other two variables, with Example 3 being least preferred. In addition to its less than ideal flow properties, which may pose processing challenges at a commercial setting, Example 3 demonstrated an early onset of translucency in the split-pizza test, just after 20 minutes. This is in contrast to about 60 and 40 minutes for the control and Examples 1-2, respectively.

It is understood that the examples and embodiments described herein are for illustrative purposes only and that various modifications or changes in light thereof will be suggested to persons skilled in the art and are to be included within the spirit and purview of this application and scope of the appended claims. The compositions of the present invention may be made by the methods described herein, or by any other method that produces a finished product having the same physical or chemical properties as the present compositions. All publications, patents and patent applications cited herein are hereby incorporated by reference in their entirety for all purposes to the same extent as if each individual publication, patent or patent application were specifically and individually indicated to be so incorporated by reference.

what is claimed is:

1. An anticaking agent composition comprising a starch loaded with a fat or fat replacement.

2. The anticaking agent as recited in claim 1, wherein said anticaking agent comprises
a. 60-95% starch; and
b. 5-40% fat or fat replacement.

3. The anticaking agent as recited in claim 2, wherein said anticaking agent comprises
a. 70-90% starch; and
b. 10-30% fat or fat replacement.

4. The anticaking agent as recited in claim 1, wherein said starch is an unmodified food starch.

5. The anticaking agent as recited in claim 1, wherein said starch is an unmodified corn starch.

6. The anticaking agent as recited in claim 1, wherein said starch is a plating starch.

7. The anticaking agent as recited in claim 1, wherein said starch is an unmodified high amylose corn starch.

8. The anticaking agent as recited in claim 1, wherein said starch is a modified starch.

9. The anticaking agent as recited in claim 1, wherein said starch is a modified corn starch.

10. The anticaking agent as recited in claim 9, wherein said starch is a highly cross-linked flash-dried starch.

11. The anticaking agent as recited in claim 1, wherein said fat is an oil.

12. The anticaking agent as recited in claim 11, wherein said oil is chosen from sunflower oil, canola oil, mineral oil, corn oil, and soy oil.

13. The anticaking agent as recited in claim 12, wherein said oil is sunflower oil.

14. The anticaking agent as recited in claim 1, wherein said fat replacement is maltodextrin.

15. The anticaking agent as recited in claim 1, wherein said fat is kosher approved mono-diglycerides made from edible, refined, fully hydrogenated vegetable fat.

16. The anticaking agent as recited in claim 1, wherein said agent is capable of modulating browning of cheese during baking.

17. The anticaking agent as recited in claim 1, wherein said anticaking agent further comprises a calcium compound.

18. The anticaking agent of claim 17, wherein the anticaking agent comprises:
a. 30.00-65.00% starch; and
b. 30.00-65.00% calcium compound; and
c. 0.10-40.00% fat by weight.

19. The anticaking agent of claim 18, wherein the anticaking agent comprises:
a. 40.00-60.00% starch; and
b. 40.00-60.00% calcium compound; and
c. 1.00-5.00% fat by weight.

20. The anticaking agent of claim 19, wherein the anticaking agent comprises:
a. 49.38% Distarch Phosphate; and
b. 49.38% calcium sulfate; and
c. 1.24% sunflower oil by weight.

21. The anticaking agent of claim 18, wherein the starch is obtained from corn, potato, wheat, rice, sago, tapioca, or sorghum.

22. The anticaking agent of claim 18, wherein the starch is a modified starch.

23. The anticaking agent of claim 18, wherein the fat is an oil.

24. The anticaking agent of claim 23, wherein the oil is sunflower oil, canola oil, palm oil, cottonseed oil, mineral oil, corn oil, or soybean oil.

25. The anticaking agent of claim 24, wherein the oil is sunflower oil.

26. The anticaking agent of claim 18, wherein the calcium compound is calcium carbonate, calcium citrate, calcium silicate, calcium stearate, or calcium sulfate.

27. The anticaking agent of claim 26, wherein the calcium compound is calcium sulfate.

28. The anticaking agent of claim 1, wherein said anticaking agent further comprises a processing aid or flow agent.

29. The anticaking agent as recited in claim 28, wherein said processing aid or flow agent is chosen from silicon dioxide and calcium phosphate.

30. The anticaking agent as recited in claim 28, wherein said processing aid or flow agent comprises less than 0.5% of the agent by weight.

31. A method of treating a divided or shredded food product for anticaking comprising applying to said food product an anticaking agent as described in claim 1.

32. A method of reducing browning of a divided or shredded food product comprising applying to said food product an anticaking agent as described in claim 1 prior to cooking.

33. The food product as recited in claim 31 or 32, wherein said food product is chosen from cheese, cheese analogue, cheese substitute, cheese extender, and processed cheese.
